(19) United States
(12) Patent Application Publication
(10) Pub. No.: US 2026/0025884 A1
(43) Pub. Date: Jan. 22, 2026

(54) OVEN DIAGNOSTIC POWERED BY A CAMERA

(71) Applicant: WHIRLPOOL CORPORATION, BENTON HARBOR, MI (US)

(72) Inventors: Alessandro Gigante, Varese (IT); Collin Andrew Stipe, St. Joseph, MI (US); Blayne Christopher Smith, St. Joseph, MI (US); Mauro Angelo Bolognesi, Biandronno (IT)

(73) Assignee: WHIRLPOOL CORPORATION, BENTON HARBOR, MI (US)

(21) Appl. No.: 18/778,248

(22) Filed: Jul. 19, 2024

(51) Int. Cl. H05B 1/02; F24C 7/08

(52) U.S. Cl. CPC H05B 1/0263; F24C 7/085

(57) ABSTRACT

An oven includes an electrical heating element that is configured to selectively heat a cooking cavity. When operating properly, the electrical heating element has a baseline correlation between at least one of voltage and electrical current supplied to the electrical heating element and radiation intensity emitted by the oven cavity and/or the electrical heating element. The oven further includes an infrared (IR) sensor that is configured to measure radiation intensity of the oven cavity and/or the electrical heating element, and a controller that is configured to compare a measured radiation intensity of the oven cavity and/or the electrical heating element to an expected radiation intensity.

### BACKGROUND OF THE DISCLOSURE

Various types of ovens have been developed for cooking food. Ovens may include an insulated cabinet and a door that is moveable to provide access to a cooking cavity. Known ovens may utilize electric or gas heat to selectively heat the cooking cavity.

### SUMMARY OF THE DISCLOSURE

An aspect of the present disclosure is an oven including a cabinet defining a cooking cavity, and a door that is moveable to an open position to provide access to the cooking cavity. The oven includes an electrical heating element that is configured to selectively heat the cooking cavity, and an infrared sensor that is configured to measure radiation intensity in the cooking cavity. The oven further includes a controller that is configured to compare a measured radiation intensity during operation to an expected radiation intensity of the cooking cavity, wherein the expected radiation intensity of the cooking cavity is based, at least in part, on a voltage and/or electrical current supplied to the electrical heating element when the radiation intensity is measured, and wherein the controller is configured to determine that the electrical heating element is defective if differences between the measured radiation intensity of the cooking cavity and an expected radiation intensity of the cooking cavity satisfy predefined criteria.

Another aspect of the present disclosure is a method of determining if an electrical heating element of an oven is operating properly. The method includes utilizing an infrared sensor maintained in the oven to measure radiation intensity in a cooking cavity of the oven. The method further includes determining if the electrical heating element is operating property by comparing a measured radiation intensity of the cooking cavity during operation to an expected radiation intensity of the cooking cavity. The expected radiation intensity of the cooking cavity is based, at least in part, on a voltage and/or electrical current supplied to the electrical heating element when the radiation intensity is measured, and the electrical heating element is determined to be defective if differences between the measured radiation intensity of the cooking cavity and an expected radiation intensity of the cooking cavity satisfy predefined criteria.

Another aspect of the present disclosure is an oven including a cabinet defining a cooking cavity, and a door that is moveable to an open position to provide access to the cooking cavity. The oven further includes an imaging device that is configured to capture images of the cooking cavity, and a controller that is configured to determine that a defect exists when intensity and/or color of light in the captured images has degraded over time.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a partially schematic isometric view of an oven according to an aspect of the present disclosure;

FIG. 2 is a cross-sectional view of the oven of FIG. 1 taken along the line II-II, FIG. 1; and

FIG. 3 is a graph showing infrared (IR) light intensity of an electrical heating element as a function of voltage.

The components in the figures are not necessarily to scale, emphasis instead being placed upon illustrating the principles described herein.

### DETAILED DESCRIPTION

The present illustrated embodiments reside primarily in a control and monitoring system of a cooking appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

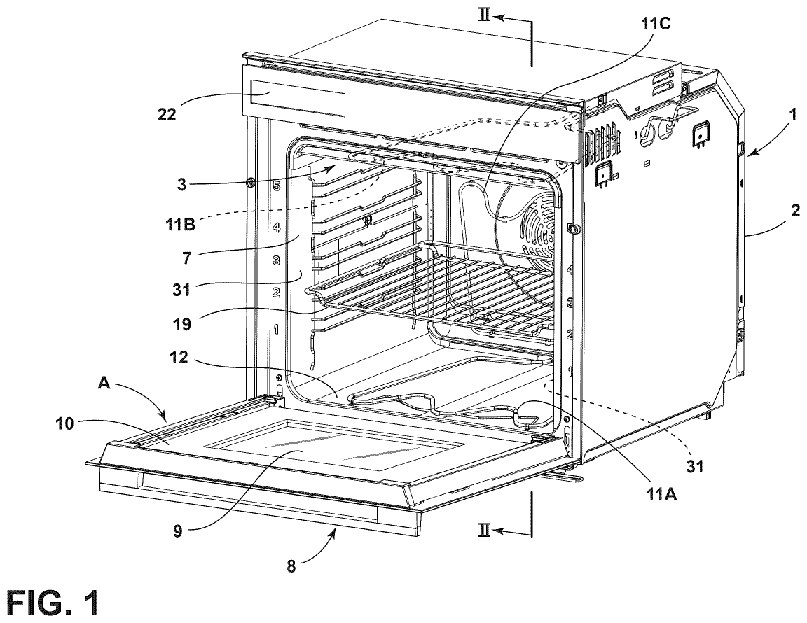

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer and/or user, and the term “rear” shall refer to the surface of the element further from the intended viewer and/or user. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

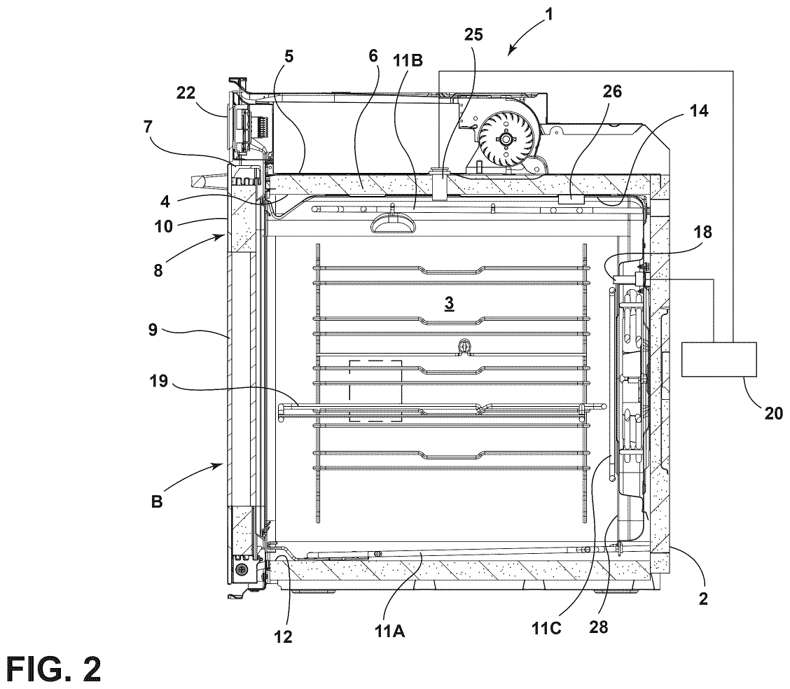

With reference to FIGS. 1 and 2, oven 1 includes a cabinet 2 defining a cooking cavity 3. Cabinet 2 may include inner and outer layers 4 and 5, respectively, and insulation 6 disposed between the layers 4 and 5. Cabinet 2 further includes an opening 7 and a door 8 that is moveable about a horizontal or vertical axis to an open position “A” (FIG. 1) to provide access to the cooking cavity 3 from a closed position “B” (FIG. 2). Door 8 may include glass 9 that is mounted to door structure 10. Cabinet 2 and door 8 may have a suitable construction that is known in the art. Oven 1 may include one or more racks 19 that are moveably supported in cooking cavity 3. Oven 1 may include a user interface 22 comprising a display screen, touchscreen, or other suitable communication interface that allows a user to input and/or receive information.

Oven 1 may include an infrared (IR) sensor 18 and one or more electrical heating elements such as an electrical heating element 11A that is positioned adjacent a lower side or surface 12 of cabinet 2, an upper electrical heating element 11B (FIG. 2) adjacent upper surface 14 of an upper portion of the cooking cavity 3, and a heating element 11C adjacent rear wall 28. The electrical heating elements 11A, 11B, and 11C are configured to selectively heat the cooking cavity 3 and surfaces of cooking cavity 3 in a manner that is generally known in the art. One or more of the electrical heating elements 11A, 11B, and 11C may be exposed (e.g. to broil food in cavity 3). One or more of the electrical heating elements 11A, 11B, and 11C may be hidden to provide hidden convection or baking. In general, hidden heating elements transfer heat primarily by conduction or convection, but may also transfer some heat by radiation (e.g. IR radiation). In general, if the heating elements are hidden, the heating elements may not be visible to infrared (IR) sensor 18. When the surfaces of cavity 3 are heated by one or more of the heating elements, the surfaces of cavity 3 emit IR radiation.

Each electrical heating element 11A-11C may be supplied with electrical power at a fixed voltage (e.g. 120V AC) in sequence for periods of time. For example, electrical heating element 11A may be powered at a (nominally) constant voltage for 30 seconds while electrical heating elements 11B and 11C are not powered, followed by electrical heating element 11B being powered at a constant voltage for 20 seconds while electrical heating elements 11A and 11C are not powered, followed by electrical heating element 11C being powered at a constant voltage for 10 seconds while electrical heating elements 11A and 11B are not powered. It will be understood that the “fixed” or “constant” voltages do not need to be precisely constant and may vary somewhat. For example, power supplied to oven 1 at nominally constant or fixed 120 or 240 volts may vary by +/−5% or more even under ideal conditions, and the “constant” voltages to the electrical heating elements may also vary significantly.

Oven 1 may include (for example) a PID controller that varies the length of time each electrical heating element 11A-11C is powered, and the lengths of time between powering each heating element may be varied to adjust the amount of heat produced by the electrical heating elements 11A-11C. It will be understood that the sequence and timing of actuation of electrical heating element 11A-11C may vary as required, and the present disclosure is not limited to a specific sequence. All electrical heating elements 11A-11C may be simultaneously actuated, or a single one of the heating elements 11A-11C may be actuated. The present disclosure is also not limited to the electrical heating elements 11A-11C, and oven 1 may optionally include a single electrical heating element, two electrical heating elements, or more than three electrical heating elements. A magnitude or time of an electrical current supplied to the electrical heating elements may also, or alternatively, be varied to control the amount of heat produced by the heating elements.

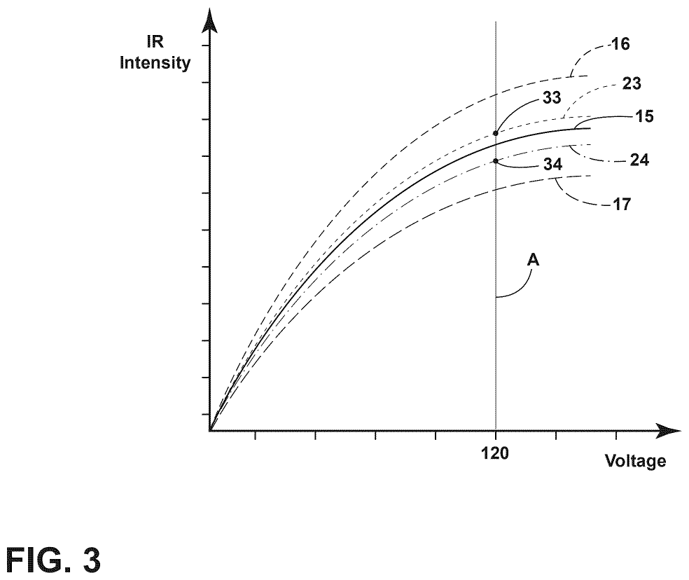

As discussed in more detail below in connection with FIG. 3, each of the electrical heating elements 11A-11C may define a baseline correlation 15 between voltage and/or electrical current supplied to the electrical heating elements 11A-11C, and a corresponding radiation intensity (e.g. infrared intensity) emitted by the surfaces of cavity 3 and/or emitted by electrical heating elements 11A-11C. Thus, an expected radiation intensity for cavity 3 and/or each electrical heating element 11A-11C can be determined based, at least in part, on voltage and/or electrical current supplied to the electrical heating elements 11A-11C. It will be understood that the expected radiation (IR) intensity may correspond to a total IR radiation intensity of cavity 3 that results from IR that is emitted by the surface(s) of cavity 3 and by the electrical heating elements. In general, if a heating element 11A-11C is operating properly, the heating element and/or the surfaces of cavity 3 will emit IR radiation at the expected intensity. The baseline correlation 15 may be determined empirically by testing electrical heating elements of the type used in oven 1 prior to fabrication of oven 1, or the baseline correlation 15 may be determined by measuring the correlation 15 (IR intensity of cavity 3 and voltage or power to the heating elements) during initial setup and operation of oven 1. Thus, the expected IR intensity may correspond to the intensity of IR emitted from one or more surfaces of the cavity 3 and/or the intensity of IR emitted from one or more heating elements when the heating element(s) is (are) operating properly.

Referring again to FIG. 2, infrared (IR) sensor 18 may be configured to measure radiation (IR) intensity of cavity 3 which may include IR radiation emitted by one or more of electrical heating elements 11A-11C and/or IR radiation emitted by one or more surfaces of cavity 3. IR sensor 18 may optionally comprise an IR camera having a plurality of pixels or it may comprise a single sensor/pixel device. Oven 1 further includes a controller 20 that is configured to determine if electrical heating elements 11A-11C are operating properly. As discussed in more detail below, the controller 20 may be configured to compare a measured radiation intensity of one or more interior surfaces of cavity 3 and/or measured radiation intensity of electrical heating elements 11A-11C to an expected radiation intensity for one or more of one or more interior surfaces of cavity 3 and/or electrical heating elements 11A-11C.

With reference to FIG. 3, if a measured IR intensity 16 or 17 for a given voltage or electrical current supplied to one or more of electrical heating elements 11A-11C deviates significantly from the baseline (expected) IR intensity (line 15), the controller 20 may determine that one or more heating elements are defective, and the controller may generate a notification to a user indicating that one or more of the electrical heating elements 11A-11C have failed, or are not operating properly. For example, controller 20 may generate a message on the user interface 22 alerting a user to the malfunction or potential malfunction of one or more of electrical heating elements 11A-11C. Controller 20 may also be configured to generate an alert to a remote device (e.g. a smartphone, a computer or other wireless device). If one or more of the electrical heating elements 11A-11C has experienced a hard (complete) failure, controller 20 may be configured to assist a user in reaching out to a service provider, which assistance may include prompting instructions (e.g. on user interface 22) that are specific to the detected defect. The instructions may comprise text or audio troubleshooting steps and/or a phone number to call for assistance and/or other contact information. Controller 20 may also be configured to provide the Part Number of a replacement part in case a replacement is needed. Controller 20 may also be configured to generate signals to a smartphone or other device concerning failure or potential failure of one or more heating elements, and provide additional information concerning troubleshooting and other information as discussed above.

Referring again to FIG. 3, controller 20 may be configured to utilize predefined criteria to determine if the electrical heating elements 11A-11C are operating according to a baseline (expected) IR intensity (line 15) of the cavity 3 and/or IR intensity of the heating element(s) within acceptable limits (predefined criteria). A predefined acceptance criteria indicative of proper heating element operation may comprise, for example, a measured IR intensity that falls between lines 23 and 24. Lines 23 and 24 may comprise +/−5%, 10%, 15%, 20%, etc. of the baseline correlation 15. Alternatively, lines 23 and 24 may comprise, for example, a specific numerical limit whereby lines 23 and 24 are parallel to line 15 (not shown). The predefined criteria may, alternatively, comprise variations from the baseline correlation 15 that have been determined by testing to constitute acceptable limits based on heating performance, efficiency, etc. It will be understood that various predefined criteria may be utilized, and lines 23 and 24 are merely an example of one potential criteria. It will be understood that FIG. 3, including line 15, is schematic in nature, and line 15 merely represents one possible baseline correlation between IR Intensity and Voltage (or electrical current), and the correlation for a given electrical heating element may vary significantly from line 15.

As discussed above, in use, nominally constant voltage (120V AC) may be supplied to one or more of heating elements 11A-11C. Constant voltage may correspond to vertical line “A” of FIG. 3. In this example, measured IR intensities above point 33 and below point 34 are indicative of a defect in a heating element 11A-11C. Also, although constant voltage may be supplied to heating elements 11A-11C, the voltage and/or electrical current supplied to the heating elements may be varied to control the temperature in oven 1, and baseline correlations between different voltages and/or electrical currents may be utilized to provide expected IR intensity for different voltages and/or electrical currents.

Referring again to FIG. 2, oven 1 may also include an imaging device such as camera 25. Camera 25 may be configured to capture images of the cooking cavity 3 in a visible light range. The camera 25 may be configured to capture images of racks 19, door glass 9, and/or other components of oven 1, and controller 20 may be configured to utilize camera images to determine if a defect (e.g. degradation) in the door glass 9, racks 19, or other components is present. For example, controller 20 may be configured to determine that a defect exists if an intensity and/or color of light in the captured images has degraded over time according to predefined criteria. Degradation may be determined by white shifting of images over time and/or changes in the intensity (brightness) of images over time. Camera 25 may include algorithms that compensate for white shifting and/or changes in light intensity to provide images that do not have significant white-shifting or significant reductions in brightness. The amount of compensation provided by the camera to avoid changes in the camera images may be utilized as a measure of the changes in color (white shifting) and/or intensity (brightness) over time. Alternatively, images may be captured and compared over time without white-shifting or intensity shifting, and the differences in the non-shifted images may be utilized to determine if a defect exists.

Oven 1 may include a light source such as light 26 that is configured to illuminate the cooking cavity 3. Oven 1 may be configured to turn on light 26 whenever oven 1 is in use whereby images from camera 25 may be utilized to monitor the inside of oven 1 while food is being cooked in oven 1. This may result in increased use of light 26 relative to conventional oven lights which may only turn on when the oven door is open. Because light 26 may be used frequently and for longer periods of time relative to conventional ovens, light 26 may tend to fail within a shorter period of time relative to conventional ovens. Also, because the light 26 provides light to assist in monitoring the interior of oven 1 using camera 25, proper functioning of light 26 may be necessary to provide for monitoring by camera 25. Oven 1 may be configured to transmit images from camera 25 to a smartphone, computer, or other device that may be remote from oven 1 to thereby permit remote monitoring of food cooking in the cavity 3 of oven 1.

Controller 20 may be configured to monitor the intensity of light emitted by light source 26 utilizing images from camera 25, and to evaluate the images to determine if degradation over time has occurred. For example, controller 20 may be configured to compare images of an empty cavity 3 generated when a lens of camera 25 and the cavity 3 are clean to a present or more recent image to determine if light emitted by light 26 is significantly compromised or is completely OFF. Controller 20 may also be configured to determine if the intensity and/or frequency of light emitted by light 26 has shifted (e.g. degraded) over time in a manner that indicates that light 26 is not functioning properly and/or is likely to fail shortly. For example, light source 26 may comprise an incandescent bulb (e.g. halogen) or an LED, and the intensity and/or frequency of the light emitted by light 26 may change or otherwise degrade over time in a manner that is at least somewhat predictable based on testing of similar lights, and controller 20 may be configured to compare measured intensity and/or frequency of the light emitted by light 26 to data for similar lights to determine if light 26 has degraded and/or is likely to fail shortly. The failure criteria may comprise a likelihood of failure (e.g. 90%) within a specific period of time (e.g. 20 hours of operation of light 26).

Controller 20 may also be configured to utilize images from camera 25 to determine if door glass 9 or other oven components have yellowed (e.g. images have white-shifted) or cracked, or if door glass 9 requires cleaning. Controller 20 may also be configured to determine if racks 19 and/or other components are defective, require cleaning, etc. utilizing neural networks and/or AI-based image capture and processing. For example, a machine learning program may be trained to recognize changes in images that are due to changes in door glass, dirty or degraded oven components, etc. In general, controller 20 may be configured to utilize color shifting and/or changes in intensity of light reflected by items in cooking cavity 3 of oven 1 to determine if an item has a defect. The defect may comprise food or other residue on an item that causes a shift in the intensity and/or frequency of light indicating that the item is dirty. The defect may also comprise a change in shape or other properties of an item indicative of dame or failure.

If controller 20 determines that a defect exists, controller 20 may be configured to alert a user (e.g. using text on interface 22 and/or a remote smartphone or other wireless device), and/or provide information concerning contact information for repair services, providing instructions for repair or cleaning, a Part No. of a part requiring replacement, or other information.

Oven 1 may include an IR sensor 18 by itself, a camera 25 by itself, or oven 1 may include an IR sensor 18 and a camera 25. It will be understood that some aspects of the drawings are schematic in nature, and the mounting location and configuration of the IR sensor 18 and/or camera 25 may be adjusted or varied as required for a particular application. For example, the IR sensor 18 and camera 25 may be positioned at virtually any suitable location in oven 1 such as upper wall 29, lower wall 30, or a side wall 31. Also, it will be understood that controller 20 may be incorporated into cabinet 20, and the position of controller 20 in FIG. 2 is schematic.

The invention disclosed herein is further summarized in the following paragraphs and is further characterized by combinations of any and all of the various aspects described herein.

According to one aspect of the present disclosure, an oven includes a cabinet defining a cooking cavity, and a door that is moveable to an open position to provide access to the cooking cavity. The oven includes at least one electrical heating element that is configured to selectively heat the cooking cavity. The electrical heating element defines a baseline correlation between voltage and/or electrical current supplied to the electrical heating element and radiation intensity emitted by the oven cavity and/or the electrical heating element. The oven further includes an infrared (IR) sensor that is configured to measure radiation intensity of the oven cavity and/or the radiation intensity of the electrical heating element. The oven further includes a controller that is configured to determine if the electrical heating element is operating property by comparing: 1) a measured correlation between voltage and/or electrical current supplied to the electrical heating element during operation and measured radiation intensity of surfaces of the oven cavity and/or the electrical heating element to: 2) the baseline correlation between voltage and/or electrical current supplied to the electrical heating element and radiation intensity emitted by the oven cavity and/or the electrical heating element.

According to another aspect of the present disclosure, the oven includes a controller configured to utilize differences between the measured correlation and the baseline correlation to determine if the heating element is operating properly.

According to another aspect of the present disclosure, the oven includes a controller configured to generate an indication that the electrical heating element is not operating properly if differences between the measured correlation exceed predefined acceptable differences.

According to another aspect of the present disclosure, the oven includes a controller configured to determine the baseline correlation by storing measured radiation intensity of the oven cavity and/or the electrical heating element for a plurality of voltages supplied to the electrical heating element during operation of the oven.

According to another aspect of the present disclosure, the oven includes a controller configured to: 1) store a plurality of measured correlations for a plurality of use cycles, each use cycle comprising turning the electrical heating element ON and OFF, and: 2) determine that failure of the electrical heating element is likely to occur if a trend of the measured correlations is approaching a predefined correlation indicative of improper operation of the electrical heating element.

According to another aspect of the present disclosure, the oven further includes an imaging device that is configured to capture images of the cooking cavity, and a controller configured to determine that a defect exists when intensity and/or color of light in the captured images has degraded over time.

According to another aspect of the present disclosure, the oven includes a controller configured to utilize predefined criteria to determine if degradation of light intensity and/or color over time is indicative of a defect.

According to another aspect of the present disclosure, the oven includes a controller configured to determine that a replacement part is required to correct a defect and provide an alert including: 1) a part number of a replacement part, and/or: 2) contact information for support services.

According to another aspect of the present disclosure, the oven includes a glass door and an accessory in the oven compartment, and the defect comprises: 1) yellowing of the glass and/or: 2) dirtying of the accessory.

According to another aspect of the present disclosure, the oven includes a controller configured to determine that a defect is present when a predefined threshold of: 1) yellowing of the glass and/or: 2) dirtying of the accessory is present, and wherein the controller is further configured to provide cleaning instructions to a user if the controller determines that a defect is present.

According to another aspect of the present disclosure, the oven includes a controller configured to determine that a defect is present by comparing captured images to stored images.

According to another aspect of the present disclosure, a method of determining if an electrical heating element of an oven is operating properly includes utilizing an infrared sensor mounted in the oven to measure radiation intensity of the oven cavity and/or the electrical heating element. The method further includes determining if the electrical heating element is operating property by comparing: 1) a measured correlation between voltage and/or electrical current supplied to the electrical heating element during operation and measured radiation intensity of the oven cavity and/or the electrical heating element to: 2) the baseline correlation between voltage and/or electrical current supplied to the electrical heating element and radiation intensity emitted by the electrical heating element.

According to another aspect of the present disclosure, the method includes utilizing differences between the measured correlation and the baseline correlation to determine if the heating element is operating properly.

According to another aspect of the present disclosure, the method includes utilizing a controller to generate an indication that the electrical heating element is not operating properly if differences between the measured correlation and the baseline correlation exceed predefined differences.

An oven according to another aspect of the present disclosure includes a cabinet defining a cooking cavity, and a door that is moveable to an open position to provide access to the cooking cavity. The oven further includes an imaging device that is configured to capture images of the cooking cavity, and a controller that is configured to determine that a defect exists if intensity and/or color of light in the captured images has degraded (shifted) over time.

According to another aspect of the present disclosure, the oven further includes a controller configured to utilize predefined criteria to determine if degradation (shifting) of light intensity and/or color over time is indicative of a defect.

According to another aspect of the present disclosure, the oven further includes a controller configured to determine that a replacement part is required to correct a defect and provide an alert including: 1) a part number of a replacement part, and/or: 2) contact information for support services.

According to another aspect of the present disclosure, the oven further includes a glass door and an accessory in the oven compartment, and the defect comprises: 1) yellowing of the glass and/or: 2) dirtying of the accessory.

An oven according to another aspect of the present disclosure includes an electrical heating element that is configured to selectively heat the cooking cavity, wherein the electrical heating element has a baseline correlation between voltage and/or electrical current supplied to the electrical heating element and radiation intensity emitted by the oven cavity and/or the electrical heating element. The oven includes a controller configured to determine if the electrical heating element is operating property by comparing: 1) a measured correlation between voltage and/or electrical current supplied to the electrical heating element during operation and measured radiation intensity of the oven cavity and/or the electrical heating element to: 2) the baseline correlation between voltage and/or electrical current supplied to the electrical heating element and radiation intensity emitted by the oven cavity and/or the electrical heating element.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An oven comprising:
a cabinet defining a cooking cavity;
a door that is moveable to an open position to provide access to the cooking cavity;
an electrical heating element that is configured to selectively heat the cooking cavity, wherein the electrical heating element has a baseline correlation between voltage and/or electrical current supplied to the electrical heating element and radiation intensity emitted by the oven cavity and/or the electrical heating element, whereby a voltage and/or electrical current supplied to the electrical heating element corresponds to an expected radiation intensity;
an infrared sensor that is configured to measure radiation intensity of the oven cavity and/or the electrical heating element;
a controller configured to compare a measured radiation intensity of the oven cavity and/or the electrical heating element during operation to an expected radiation intensity of the oven cavity and/or the electrical heating element, wherein the expected radiation intensity of the oven cavity and/or the electrical heating element is based, at least in part, on a voltage and/or electrical current supplied to the electrical heating element when the radiation intensity is measured, and wherein the controller is configured to determine that the electrical heating element is defective if differences between the measured radiation intensity of the oven cavity and/or the electrical heating element and an expected radiation intensity of the oven cavity and/or the electrical heating element satisfy predefined criteria.

2. The oven of claim 1, wherein:
the oven is configured to operate the electrical heating element at a nominally constant predefined voltage;
the expected radiation intensity comprises a baseline radiation intensity corresponding to the predefined voltage.

3. The oven of claim 2, wherein:
the controller is configured to generate an indication that the electrical heating element is defective if differences between the measured radiation and the expected radiation exceed predefined acceptable differences.

4. The oven of claim 1, wherein:
the controller is configured to determine the baseline correlation by storing measured radiation intensity of the oven cavity and/or the electrical heating element for a plurality of voltages and/or electrical currents supplied to the electrical heating element during operation of the oven.

5. The oven of claim 4, wherein:
the controller is configured to: 1) store a plurality of measured correlations for a plurality of use cycles, each use cycle comprising turning the electrical heating element ON and OFF, and: 2) determine that failure of the electrical heating element is likely to occur if a trend of the measured correlations is approaching, or exceeds, a predefined correlation indicative of improper operation of the electrical heating element.

6. The oven of claim 1, wherein:
the oven further includes an imaging device that is configured to capture images of the cooking cavity in at least some visible frequencies of light; and
the controller is configured to determine that a defect exists or is likely to occur in the cooking cavity or components in the cavity when an intensity of light and/or a color of light in the captured images has shifted over time.

7. The oven of claim 6, wherein:
the controller is configured to utilize predefined criteria to determine if shifting of light intensity and/or color over time is indicative that a defect exists or is likely to occur within a predefined period of time.

8. The oven of claim 6, wherein:
the controller is configured to determine that a replacement part is required to correct the defect, and to provide an alert including: 1) a part number of a replacement part, and/or: 2) contact information for support services.

9. The oven of claim 6, wherein:
the door includes glass;
the oven includes an accessory in the oven compartment; and
the defect comprises: 1) yellowing of the glass and/or: 2) dirtying of the accessory according to predefined criteria.

10. The oven of claim 9, wherein:
the controller is configured to determine that a defect is present when a predefined threshold of: 1) yellowing of the glass and/or: 2) dirtying of the accessory is present; and
the controller is configured to provide cleaning instructions to a user if the controller determines that a defect is present.

11. The oven of claim 10, wherein:
the controller is configured to determine that a defect is present by comparing captured images to stored images.

12. A method of determining if an electrical heating element of an oven is operating properly, the method comprising:
utilizing an infrared sensor to measure radiation intensity of an oven cavity and/or the electrical heating element; and
determining if the electrical heating element is operating properly by comparing a measured radiation intensity of the oven cavity and/or the electrical heating element during operation to an expected radiation intensity of the oven cavity and/or the electrical heating element, wherein the expected radiation intensity of the oven cavity and/or the electrical heating element is based, at least in part, on a voltage and/or electrical current supplied to the electrical heating element when the radiation intensity is measured, and the electrical heating element is determined to be defective if differences between the measured radiation intensity of the oven cavity and/or the electrical heating element and an expected radiation intensity of the oven cavity and/or the electrical heating element satisfy predefined criteria.

13. The method of claim 12, including:
operating the electrical heating element at a nominally constant voltage; and wherein:
the expected radiation intensity comprises a baseline radiation intensity corresponding to the nominally constant voltage.

14. The method of claim 13, including:
utilizing a controller to generate an indication that the electrical heating element is not operating properly if differences between the measured radiation intensity of the oven cavity and/or the electrical heating element and an expected radiation intensity of the oven cavity and/or the electrical heating element exceed predefined acceptable differences.

15. An oven comprising:
a cabinet defining a cooking cavity;
a door that is moveable to an open position to provide access to the cooking cavity;
an imaging device that is configured to capture images of the cooking cavity; and
a controller that is configured to determine that a defect exists when intensity and/or color of light in the captured images has degraded over time according to predefined criteria.

16. The oven of claim 15, wherein:
the controller is configured to utilize predefined criteria to determine if degradation of light intensity and/or color over time is indicative of a defect.

17. The oven of claim 15, including:
a light that is configured to illuminate at least a portion of the cooking cavity; and wherein:
the controller is configured to utilize shifts in an intensity and/or frequency of light emitted by the light to determine if the light is not operating properly and/or is likely to fail.

18. The oven of claim 15, wherein:
the door includes glass;
the oven includes an accessory in the oven compartment; and
the defect comprises: 1) yellowing of the glass and/or: 2) dirtying of the accessory.

19. The oven of claim 18, wherein:
the controller is configured to determine that a defect is present when a predefined threshold of: 1) yellowing of the glass and/or: 2) dirtying of the accessory is present; and
the controller is configured to provide cleaning instructions to a user if the controller determines that a defect is present.

20. The oven of claim 15, including:
an infrared (IR) sensor;
an electrical heating element that is configured to selectively heat the cooking cavity, wherein the electrical heating element has a baseline correlation between voltage supplied to the electrical heating element and radiation intensity the oven cavity and/or emitted by the electrical heating element; and wherein:
the controller is configured to determine if the electrical heating element is defective by comparing a measured radiation intensity emitted by the oven cavity and/or electrical heating element to an expected radiation intensity of the oven cavity and/or the electrical heating element, wherein the expected radiation intensity is based, at least in part, on the baseline correlation between voltage supplied to the electrical heating element and radiation intensity emitted by the oven cavity and/or the electrical heating element.
